(19) United States
(12) Patent Application Publication
(10) Pub. No.: US 2010/0211578 A1
(43) Pub. Date: Aug. 19, 2010

(54) PATENT CONNECTION DATABASE

(75) Inventors: Steven W. Lundberg, Edina, MN (US); Janal Kalis, Minneapolis, MN (US)

Correspondence Address: SCHWEGMAN, LUNDBERG & WOESSNER, P.A., P.O. BOX 2938, MINNEAPOLIS, MN, 55402, US

(73) Assignee: Patent Buddy, LLC, Minneapolis, MN (US)

(21) Appl. No.: 12/705,299

(22) Filed: Feb. 12, 2010

Related U.S. Application Data
(60) Provisional application No. 61/152,550, filed on Feb. 13, 2009.

(51) Int. Cl. G06F 17/30; G06F 7/08; G06F 3/048

(52) U.S. Cl. 707/752; 707/796; 707/767; 715/835; 707/E17.014; 707/E17.104

(57) ABSTRACT

In an embodiment, a computer system includes a plurality of inventor profile records stored on one or more storage devices, the plurality of inventor profile records each recording a name of a living person in a name field. The system further includes a plurality of patents represented by a plurality of patent records stored on the one or more storage devices, wherein each patent record records at least an inventor name and a patent number, in respectively, at least one inventor name field and a patent number field. A computer program operable on one or more processors adapts a computer system to display a patent search interface on a display device, the patent search interface including at least one field or selection tool to receive patent search criteria input from at least one user input device to match to one or more fields in a patent record.

### CROSS-REFERENCE TO RELATED APPLICATIONS

This application claims the priority of U.S. Provisional Application Ser. No. 61/152,550, filed Feb. 13, 2009, which is incorporated herein by reference in its entirety.

### BACKGROUND

There are million of issued and pending patents in the United States of America alone, each with one or more inventors listed on the patent. Regulatory websites, such as the United States Patent and Trademark Office's website, allow users to search through this collection of patents and applications. Information associated with the patents such as inventorship, assignee, class, and related patents is also made available to users of the USPTO web site in free text form.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BRIEF DESCRIPTION OF THE DRAWINGS

Some embodiments are illustrated by way of example and not limitation in the figures of the accompanying drawings in which:

FIG. 1 is a network diagram illustrating a system, according to an example embodiment;

FIG. 2 is a system diagram of a server device, according to an example embodiment;

FIG. 3 is database diagram illustrating relationship between user profiles, according to an example embodiment;

FIGS. 4-27 are example user interfaces, according to example embodiments; and

FIG. 28 illustrates a computer system, according to an example embodiment.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one. In this document, the term “or” is used to refer to a nonexclusive or, unless otherwise indicated.

### Overview

In an example embodiment, a patent connection system maintains a plurality of user profiles. The user profiles may have one or more roles associated with the patenting process. For example, there may be an inventor profile role. Users of the system (registrants) may interact with the system through a combination of input and display devices (e.g., a website displayed on a monitor and a mouse). Roles may include, but are not limited to, inventors, patent attorneys, assignees, patent examiners, and litigants.

In some example embodiments, a user profile may designate one or more patents with which it is associated. For example, a user profile with an inventor role may be associated with a patent in which there is a textual match between a registrant's name and an inventor's name listed on the patent. In an example embodiment, a home screen may be displayed to a registrant on a display device upon the system receiving verified login credentials (e.g., user name and password). The home screen may display one or more patents that have been designated by the user profile through a textual match or other methods.

In further example embodiments, a first user profile may indicate a connection is to be made to a second user profile. In one example embodiment, a connection between two user profiles signifies that the registrants of the two user profiles have agreed to allow information to be shared between the user profiles. In various embodiments, a user profile may configured to watch another user profile. Watching may include monitoring a user profile for changes. In some example embodiments, information associated with connected user profiles and watched user profiles is displayed on the home screen. Suggested connections may also be displayed to registrants of the system based on information associated with the user such as patents on which they are listed as an inventor.

While this document focuses on patents, other uses may include other professional fields that include public or private databases that have records that people may wish to create relationships around. For example, a system may be created around the tax system with users registering and then having tax information scraped into a system which may include who prepared a person's taxes. Suggested connections may then be made surrounding this scraped information. Other possible uses include creating a network based on real estate records.

### System Structure

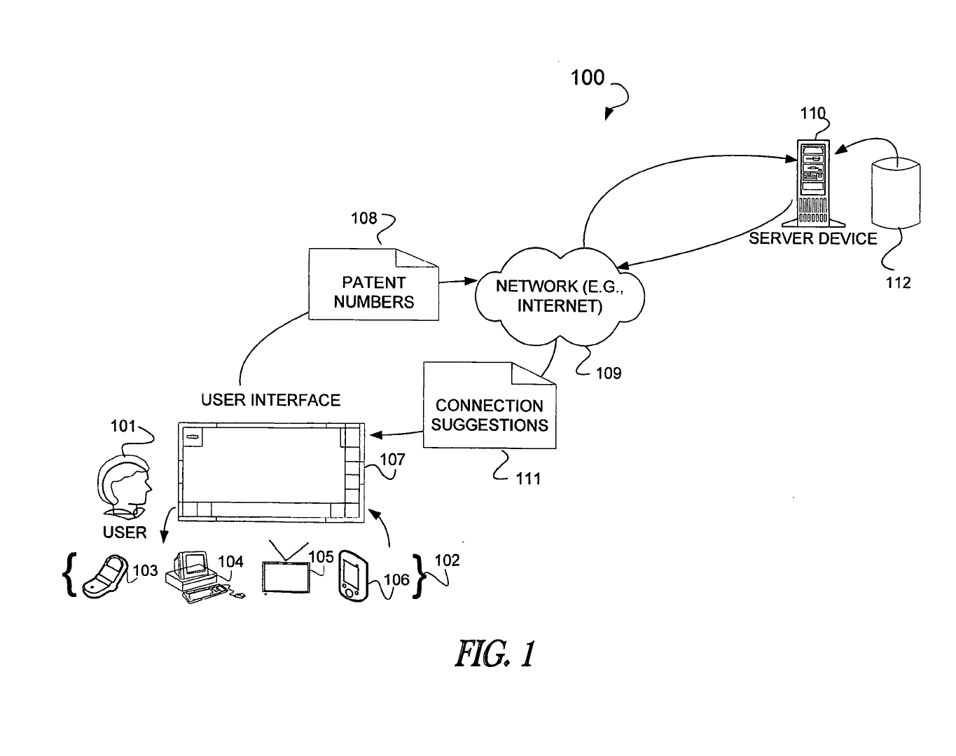

FIG. 1 is a diagram of an example system 100. Shown is a user 101, utilizing a user interface 107 that resides on any one of a number of user devices 102. These devices 102 may include, for example, a cell phone 103, a computer system 104, a television 105, and/or a Personal Digital Assistant (PDA) 106. The user device 102 may be connected to a network 109 (e.g., the Internet). Also shown is a server device 110 that may be connected to network 109. In an example embodiment, server device 110 includes a web server. A user profile database 112 may be coupled to the server device 110. In an example embodiment, the user 101 may use the user interface 107 to send one or more patent numbers 108 to the server device 110 through network 109. Server device 110 may send connection suggestions to user interface 107. In an example embodiment, the one or more patent numbers 108 are patent numbers the user requests his or her user profile designate as being associated with the user in the user profile database 112.

It will be appreciated that the present invention may be relevant to other applications, but the following sections will assume the example of the user 101 using a personal computer as the user device 102 and an internet browser (such as Internet Explorer distributed by Microsoft) as the user interface 107. In an example embodiment, user profile database 112 maintains connections between user profiles and designations as indicated by users.

In some example embodiments, the one or more patent numbers 108 may be sent to more than one server device 110. Further, server device 110 may be connected to a plurality of additional server devices. Additionally, server device 110 may be connected to a plurality of other databases in addition to user profile database 112. Further, though not depicted, this server device 110 and/or plurality of server devices may be operatively coupled to any one of a number of databases that may serve as an intermediary between the server device 110 and databases such as user profile database 112.

User device 102 may communicate the one or more patent numbers 108 to network 109 in one or more manners. Some examples may include, but are not limited to, direct wired communication (e.g., through an Ethernet connection) and wireless communication (e.g., 802.11a/b/g/n). In another example embodiment, the user device 102 may communicate through a network hub or router which then communicates with network 109.

In an example embodiment, the server device 110 may communicate with network 109 in one or more manners. Some examples may include, but are not limited to, direct wired communication (e.g., through an Ethernet connection) and wireless communication (e.g., 802.11a/b/g/n). In another example embodiment, server device 110 may communicate through a network hub or router which then communicates with network 109.

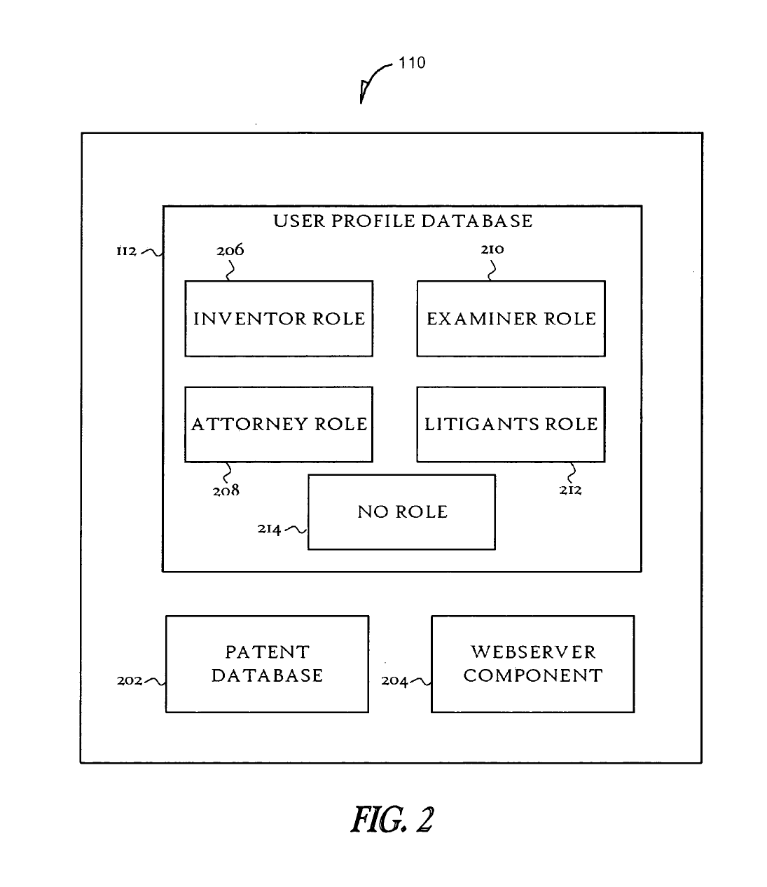

FIG. 2 illustrates a server device 110 including a patent database 202 user profile database 112, and web server component 204 according to an example embodiment. In some example embodiments, databases 202 and 112 are implemented using a relational database management system (RDBMS) such as MySQL. Patent database 202 may store a plurality of patent records which may be manually or automatically be entered. For example, server device 112 may scrape patent data from external websites such as the USPTO website. Example embodiments may further include international patents. Patent data may include metadata concerning the patent or the complete patent text. For example, the metadata may include, but is not limited to, title, abstract, inventor(s), assignee, application number, filing data, related matters, U.S. class, International class, field of search, and examiner. The scraping may be done at periodic intervals to ensure that patent database 202 is up-to-date. In an example embodiment, web server component 204 is responsible for scraping patent data, transmitting web pages to users, and processing input from the users. Communications between the users and server device 110 may utilize HTTP or other network protocols.

Example user profile database 112 includes exemplary representation of differing user profile roles. Illustrated is an inventor role 206, attorney role 208, examiner role 210, and litigants role 212. While only four roles are shown, the system may support the creation of additional roles as defined by an administrator of the system. An inventor role may be identified in one or more storage devices as an inventor profile record. Additionally, it may be possible for a user profile to be generated with no role 214 defined. In further example embodiments, temporary profiles may be generated by the system or by privileged user profiles. In an example embodiment, the role of the user profile facilitates textual matching between a user profile stored in a user profile database and a patent database. For example, the textual match between an inventor's user profile and a patent may be between the inventor's name as stored in the user profile as an inventor name field and an inventor field in a patent record stored in the patent database. The textual match between an assignees' user profile and a patent may be between the assignees' name as stored in the user profile and an assignee field in a patent record stored in the patent database.

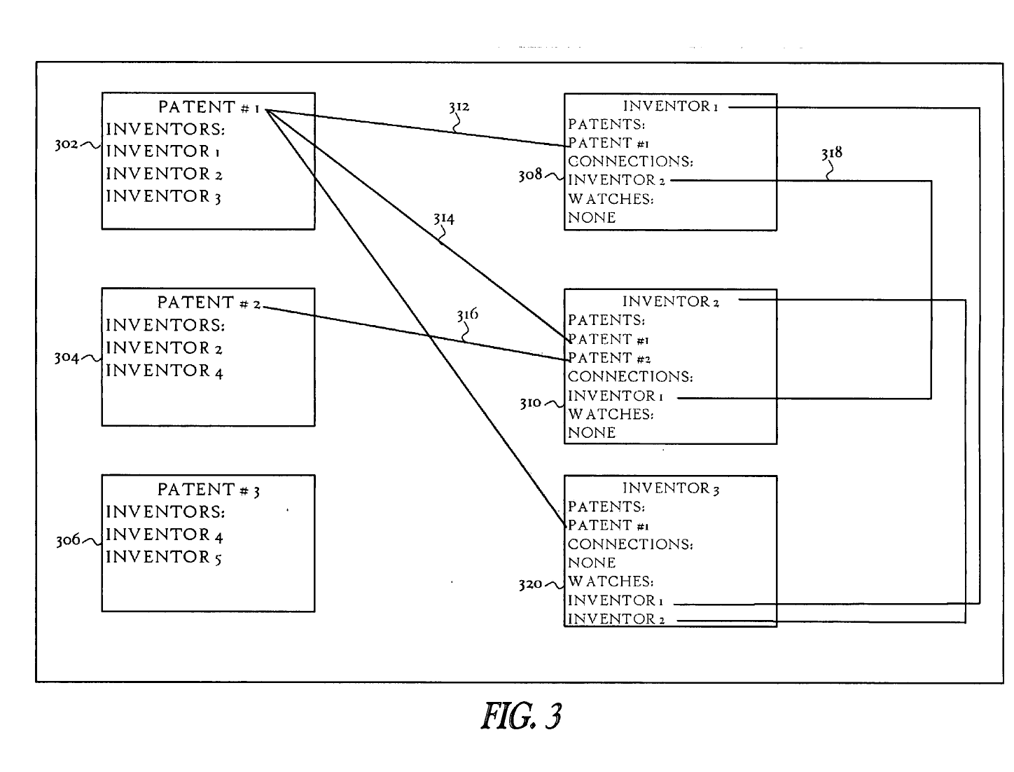

FIG. 3 illustrates example relationships between inventor user profiles and patents. Shown are example patents 302, 304, and 306 and example user profiles 308, 310, and 320. The example patents and user profiles only show a subset of the information that may be stored in a patent entry and user profile entry, respectively. Example patents 302, 304, and 306 each are shown with their patent numbers and one or more inventors. Example user profiles 308, 310, and 320 are shown with user profile names, the role of an inventor, designated patent numbers, and designated user profile connections, and designated user profile watches. As can be seen, profile 308 has a name of John Smith and designates patent 302 through the use of textual match 312. Further shown are textual matches 314 and 316 illustrating the possibility that a user profile may designate more than one patent. User profile 308 has designated user profile 310 as illustrated by connection 318. As connections are often reciprocal arrangements, user profile 310 has designated user profile 308. User profile 320 has designated user profiles 308 and 310 for watching, but as illustrated, user profiles 308 and 310 do not have reciprocal watches.

### Example User Interfaces

To facilitate use of the system, one or more user interfaces may be presented to registrants of the system. For example, there may be an enrollment interface, a home screen interface, and a search interface. Each interface may have one or more input fields and activity controls which allow users to interact with data stored in the system. The interfaces may be displayed to registrants and users of the system on one or more display devices. Information placed into the input fields and activations of the activity controls may be transmitted to the server device for processing. In some example embodiments, the user interfaces are embedded within webpages that are presented on the display device. In further example embodiments, the interfaces are included as part of a network enabled stand-alone application.

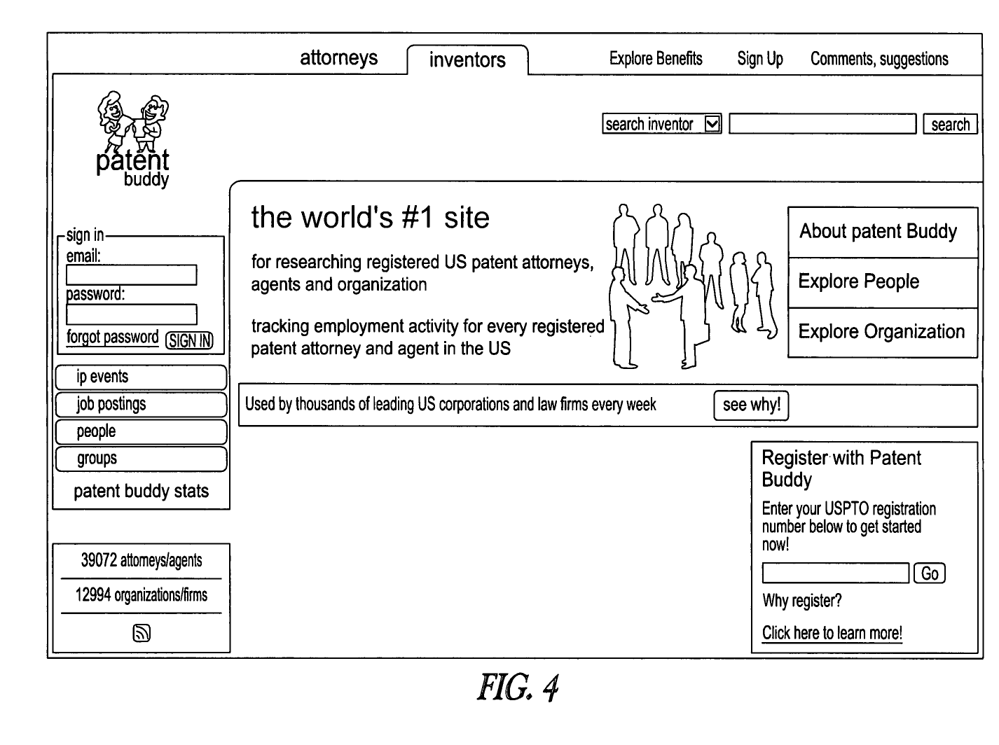

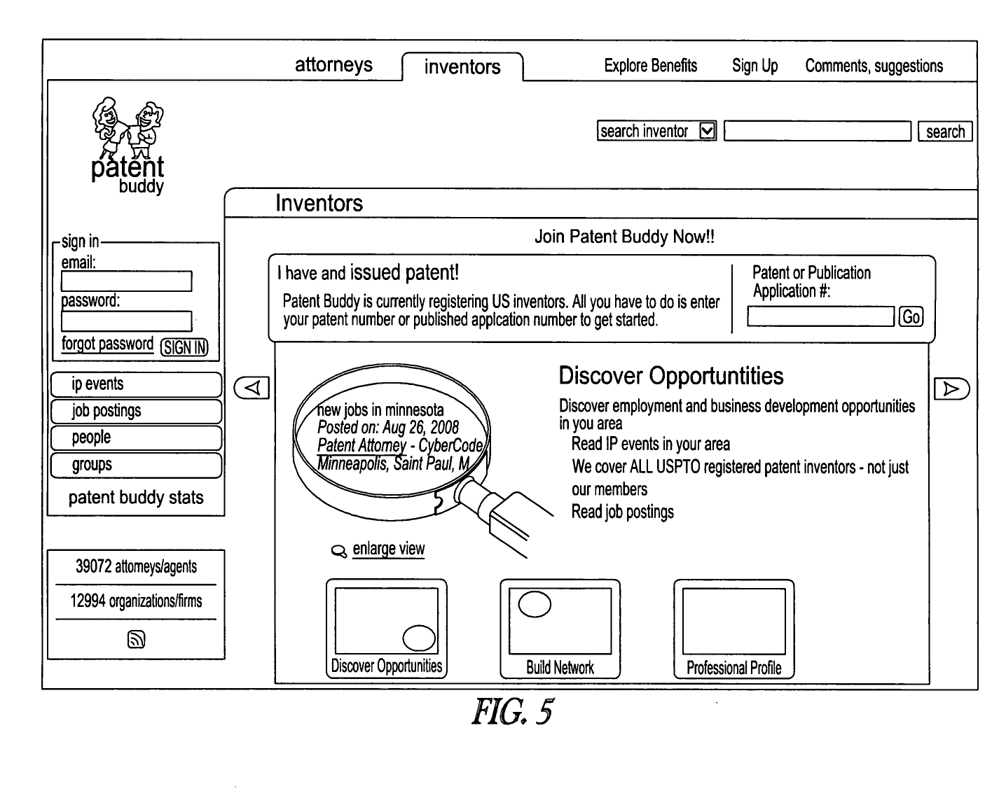

In an example embodiment, the enrollment interface is used by registrants to create a user profile and be registered with the system. Upon successfully registering, a user profile record may be stored in a user profile database. FIGS. 4-6 illustrate example user interfaces that may be presented to a user for enrollment. FIG. 4 is an example webpage that may be presented to user's of the system who have not yet registered. Example input controls allow a user to begin the registration process by entering a USPTO registration number. FIG. 5 is an example interface which allows an inventor to enter a patent or publication application number to begin the registration process.

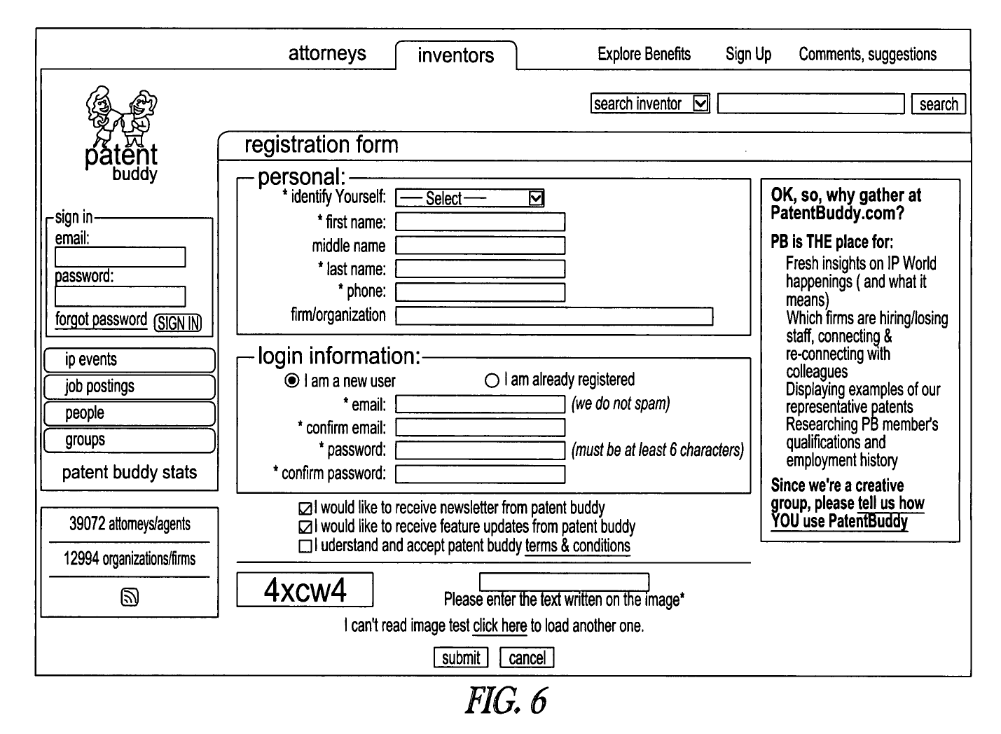

FIG. 6 illustrates an example user interface which may be presented to a user after a patent number/application number has been received from the example user interface presented in FIG. 5. FIG. 6 further displays a plurality of input fields to further the registration process which include first name, middle name, last name, phone number, firm/organization, e-mail, and password. Other input fields may be included, but are not limited to, technology interests, primary role, and known patents in which the registrant is affiliated with respect to the primary role. In an example embodiment, if the user has entered a patent number that is present in the system the example “identify yourself” pull-down will be populated with inventors associated with the patent.

The registrant may fill in the input fields using an input device (e.g., a mouse, touch screen, keyboard) and the inputted information may be transmitted to the server device. In an example embodiment, the server device creates a user profile for the registrant and stores the user profile in a user profile database as user profile record. If the user profile is for an inventor an inventor profile record may be stored in the database. In some example embodiments, the server device attempts to verify the information received for the registrant. For example, if a chosen user name is not available, the server device may request the submission of an alternate user name. In an example embodiment, after the creation of the user profile, the user profile is transformed such that the user profile designates the patents submitted by the user as being associated with the user profile. This may be accomplished through identifying a textual match between the user profile and the submitted patents. As discussed above, the textual match may between any portion of the patent and registrant's submitted information (e.g., inventor of a patent and the name of the registrant). Transforming the user profile may include adding additional data fields for each patent identified by the user.

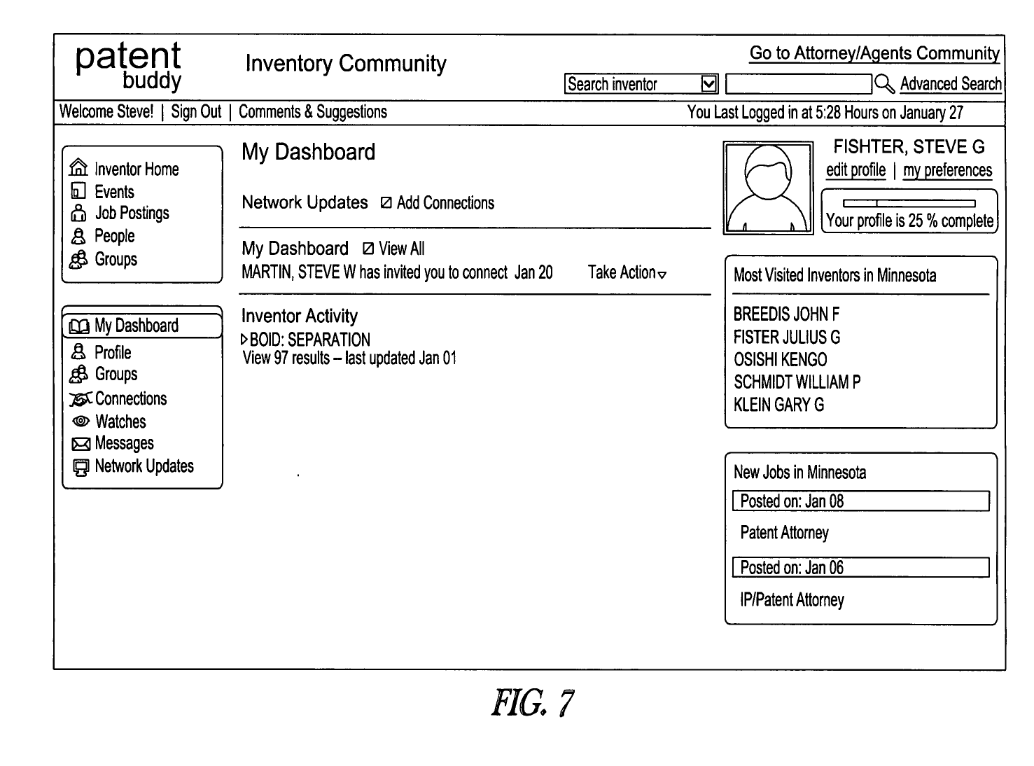

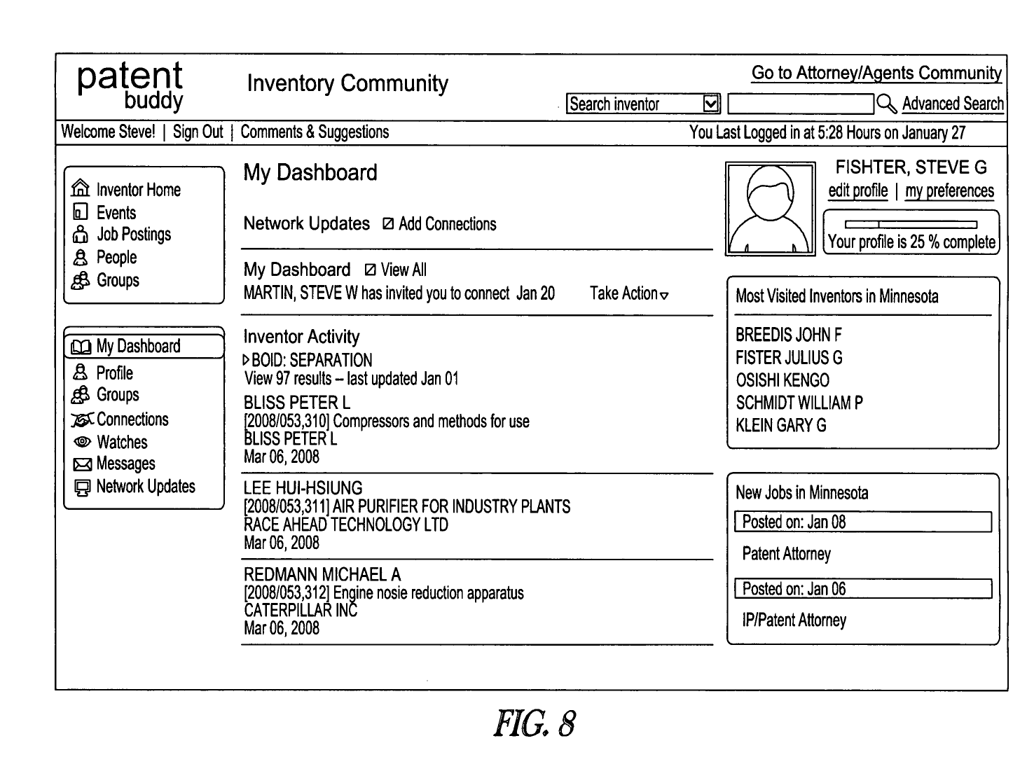

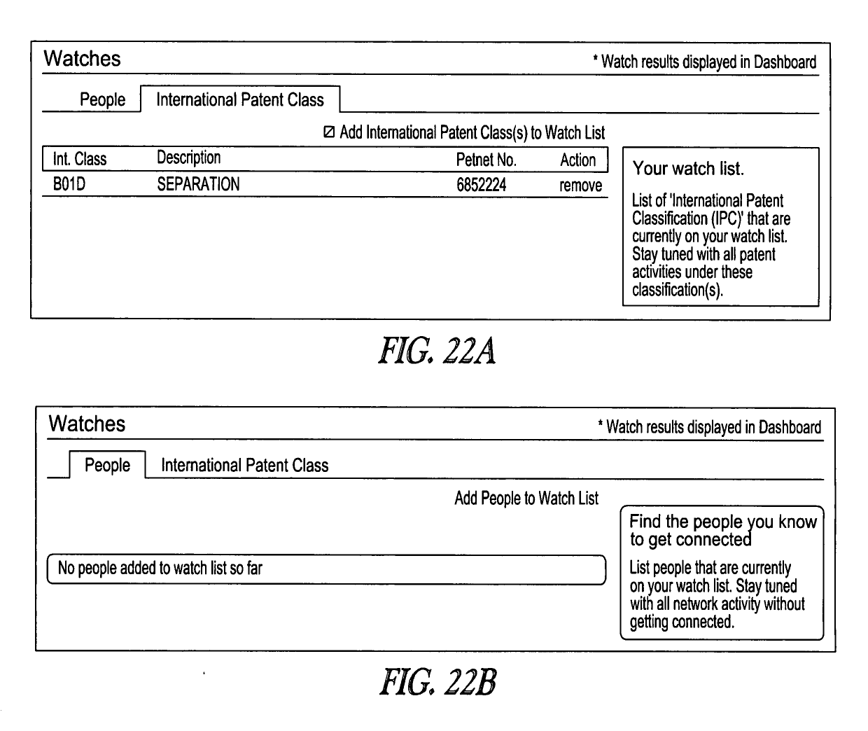

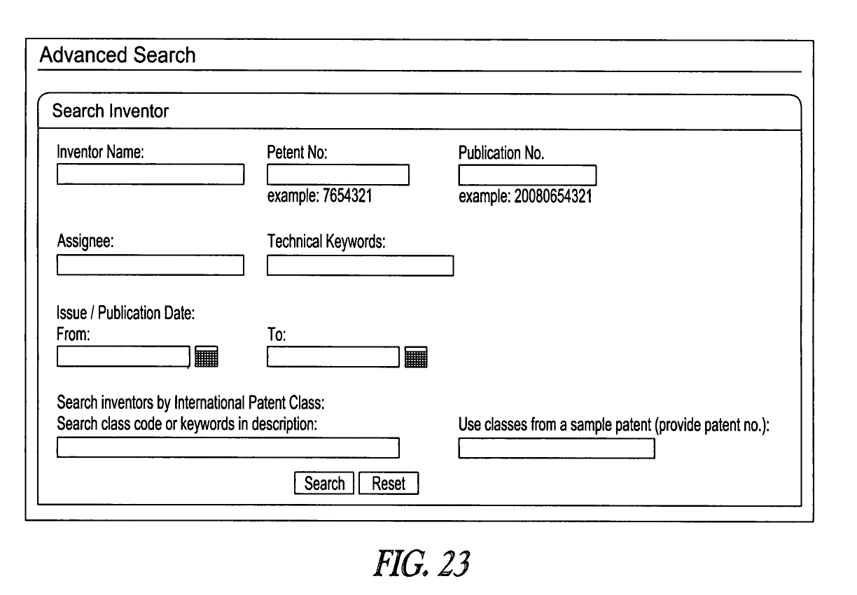

FIG. 7 illustrates an example home screen interface. In an example embodiment, the home screen interface presents an overview of information associated with a user profile. Displayed are example links related to the user's profile, group, connections, watches, messages, and network updates. In a some example embodiments, the interface may show pending invitations as well information related to watches that have been set up (see e.g., FIGS. 22-23). FIG. 8 illustrates another example home screen interface with inventor activity being shown for a specific technology class.

In an example embodiment, network updates are messages that are displayed associated with user profiles connected to the current user profile. Connection suggestions may be suggested user profile connections based on textual matches between two user profiles or relation matching. In further example embodiments, the watch feed displays messages associated with user profiles or patents designated by the current user profile.

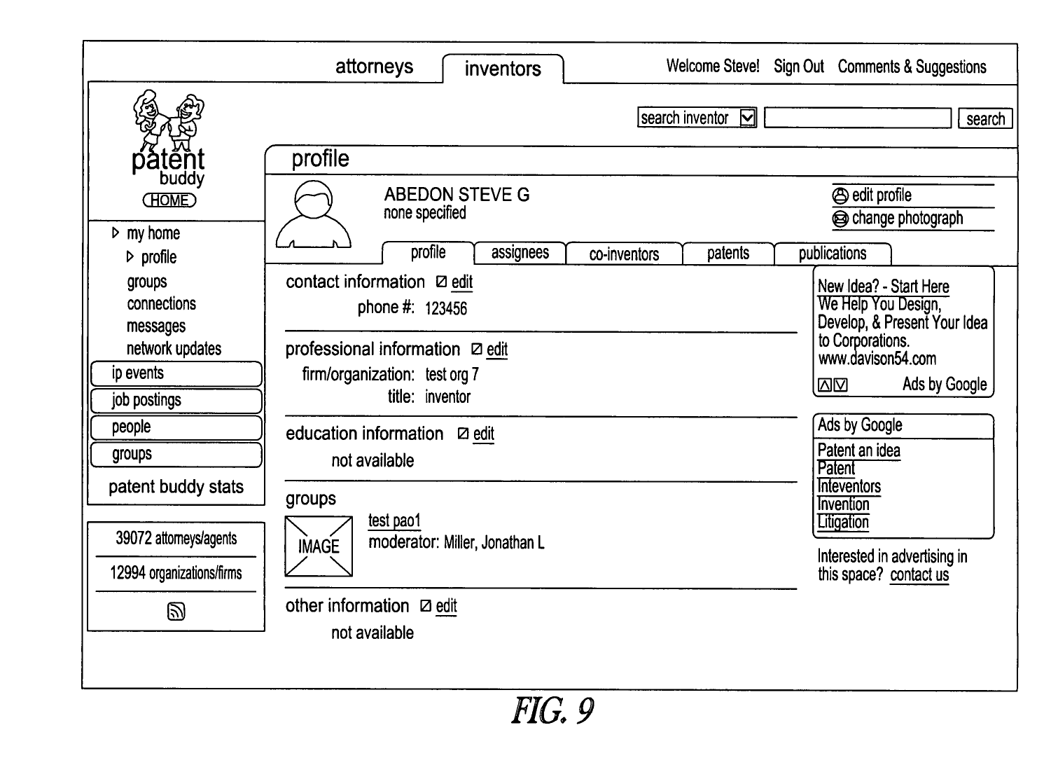

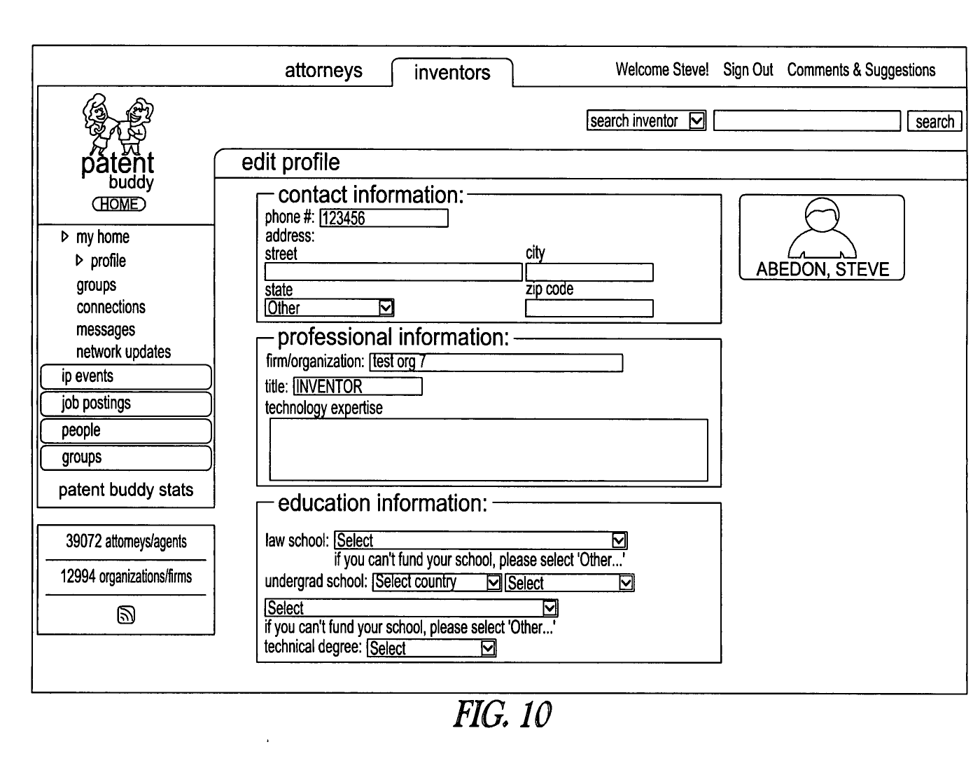

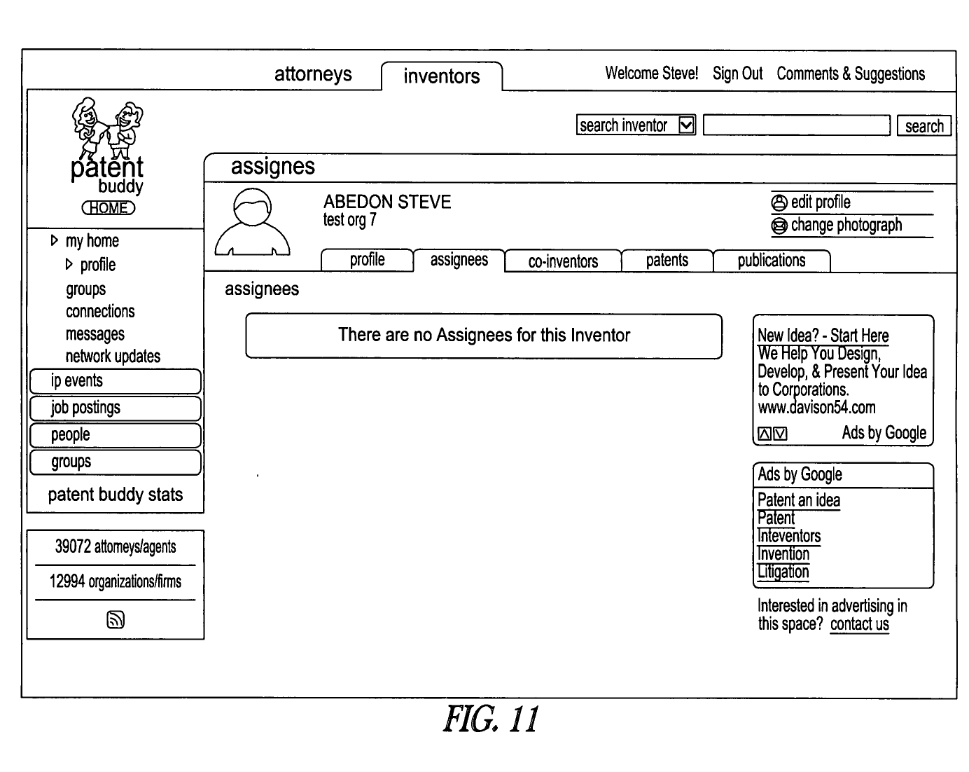

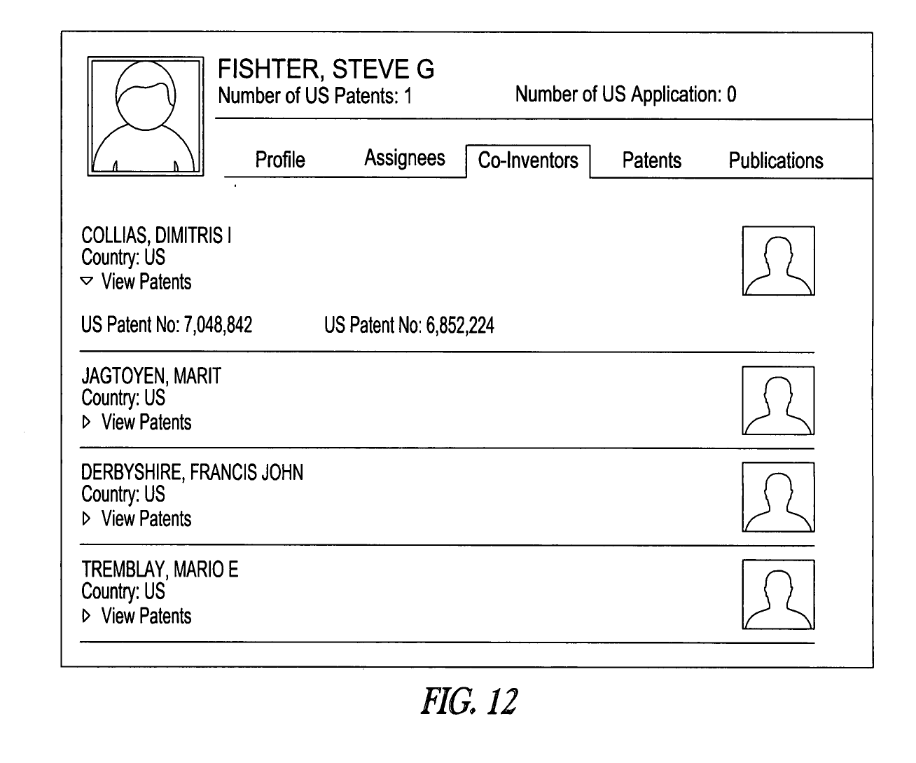

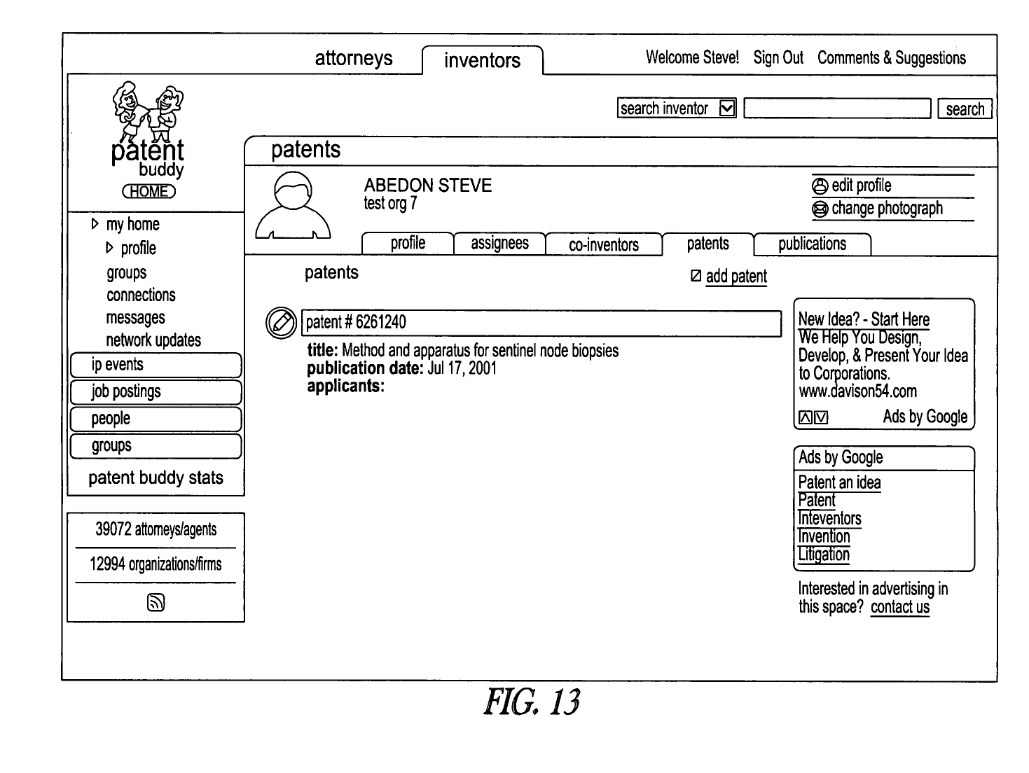

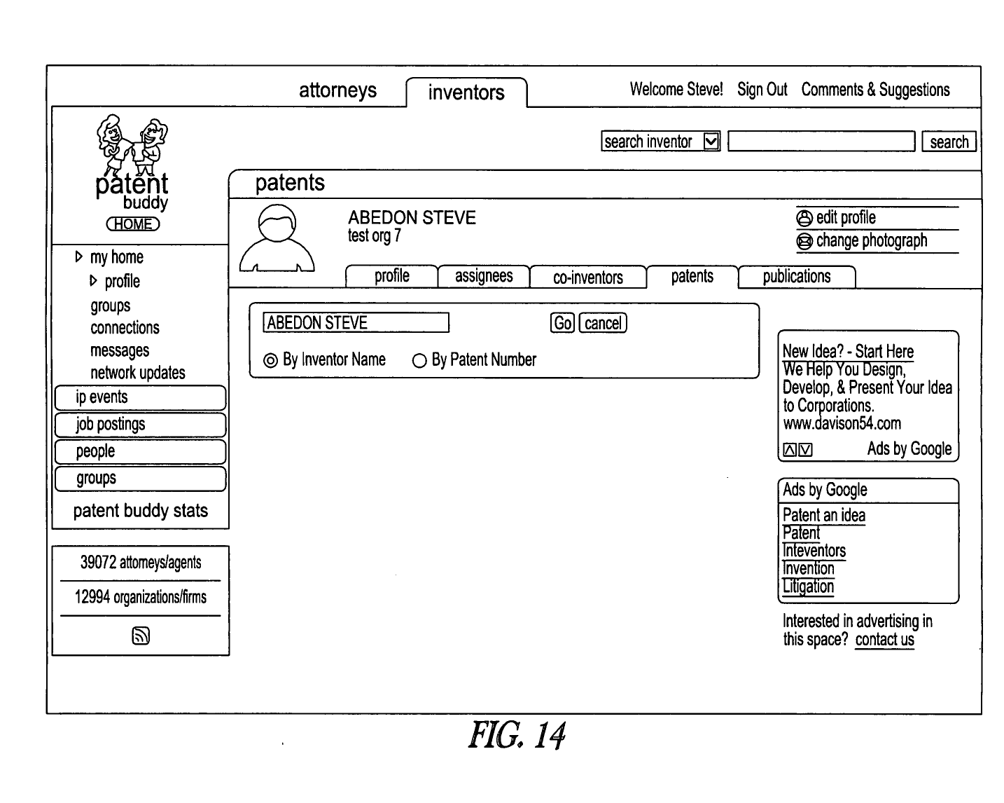

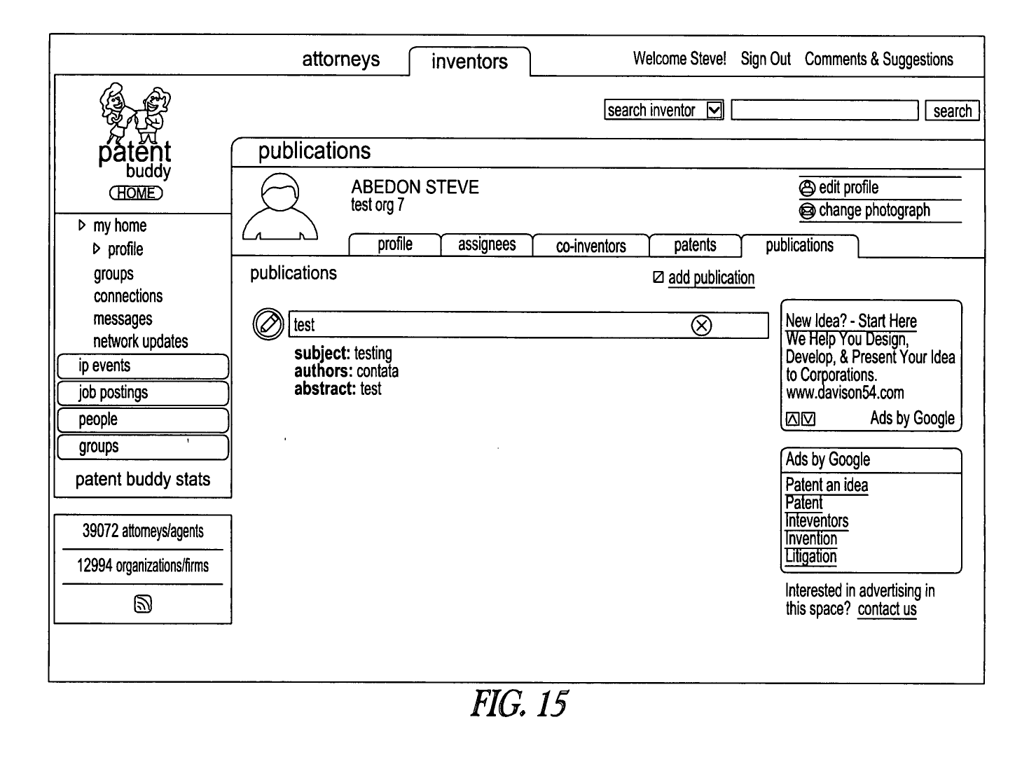

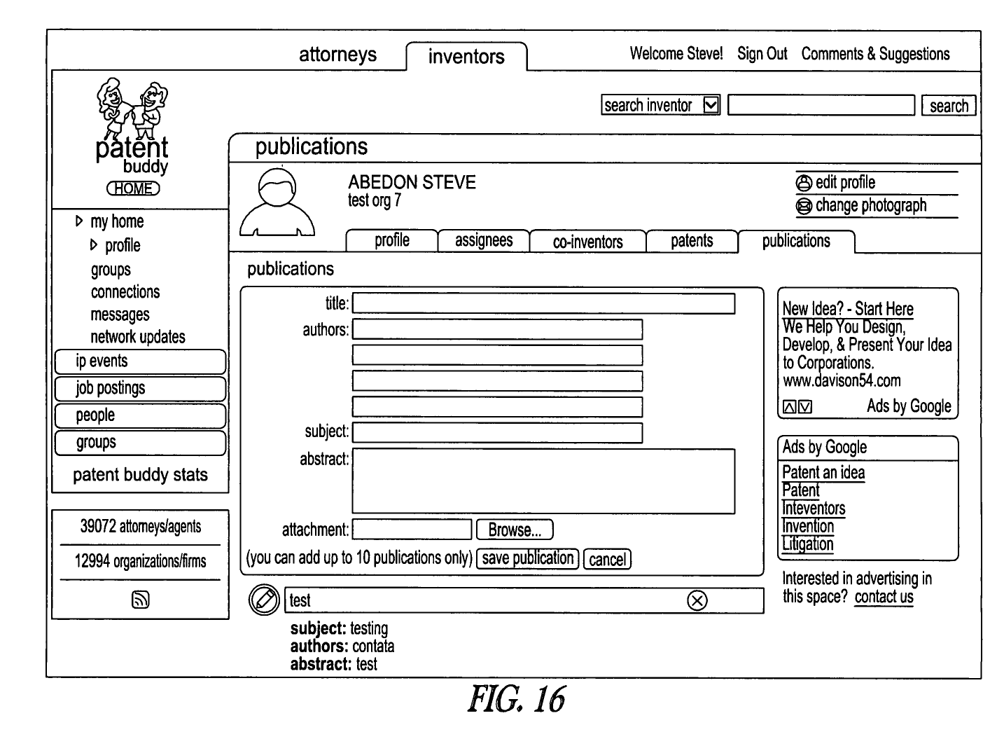

FIG. 9 illustrates an example user interface used to show information associated with a user's profile. The interface may be shown in response to a user clicking on the example profile link displayed in FIG. 7. As displayed, there may be five portions of the profile: profile, assignees (see e.g., FIG. 11), co-inventors (see e.g., FIG. 12), patents (see e.g., FIGS. 13-14), and publications (see e.g., FIGS. 15-16). FIG. 9 displays an example profile with contact information, professional information, educational information, groups, and other information. Further displayed are example controls that allow a user to edit the information related to the aforementioned categories. In an example embodiment, FIG. 10 is displayed when a user clicks or activates the “edit” link displayed in FIG. 9. Displayed is example information that may be associated with the user profile. Other example information not shown may include, but is not limited to suggested patents to associate the user profile with, connection suggestions, a watch feed, and a list of patents designated by the user profile as associated patents.

FIG. 11 illustrates an example user interface that may display assignee lists that are associated with the user profile. For example, the system may parse the patent(s) or application(s) the user has input for assignee information and display the assignees in a user interface such as displayed in FIG. 10. FIG. 12 illustrates an example user interface displaying co-inventors associated with a user profile. Similar to assignee information, co-inventors may be parsed from patent information.

FIG. 13 illustrates an example user interface to facilitate the selection of and display of patents associated with a user profile. FIG. 13 illustrates an example association of one patent. Also displayed is a control to add a patent. Upon clicking the control, a user interface such as FIG. 14 may be displayed. Here a user may add a patent by searching for inventor names or directly by patent number. Example searching user interfaces are discussed in greater detail below.

In an example embodiment, suggested patents are displayed in a user interface such as illustrated in FIG. 13 of FIG. 8. In one example embodiment, suggested patents are those patents in which the server device has determined may be related to the user profile through a textual match.

In an example embodiment, the system utilizes information stored in the one or more databases to generate a suggested patents list for a user profile. The system may look for textual matches between the name stored in the user profile and the inventor(s) on patents stored in the patent database. In example embodiments, the textual match may include variants such that “Joe Smith” matches to “Joseph Smith.” In further example embodiments, approximations may be included such that “Joe Smith” matches potential improperly entered information (e.g., “Joa Smith”).

Further, suggested patents may come from temporary profiles. In an example embodiment, a temporary profile may have been created by a privileged user profile that has designated one or more patents as being associated with the temporary profile. For example, a privileged role may include an attorney role such that the attorney knows patent ABC and patent XYZ both have the same inventor. The attorney may create a temporary profile that designates patents ABC and XYZ as associated patents. The temporary profile may be used in at least two ways. First, upon a registrant registering with the system, matching temporary profiles may be displayed to the registrant. The registrant may verify that one or more of the temporary profiles includes patents in which he or she is listed as the inventor. The system may then transform the current user profile to include patents designated by the temporary profile. In an example embodiment, verified temporary profiles are erased from the system.

Second, a temporary profile may be used upon the active user profile designating a patent to be associated with. For example, assume the system receives a command to have a user profile designate patent ABC as an associated patent. The system may detect that the temporary profile described above designates patent ABC as an associated patent. The system may then include patent XYZ as a suggested patent. In an example embodiment, the system first verifies that patent XYZ includes at least an approximate textual match between the user profile and patent XYZ (e.g., inventor name and registrant's name).

FIG. 15 illustrates an example user interface to facilitate the selection of and display of publications associated with a user profile. FIG. 15 illustrates an example association of example publication. Also displayed is a control to add a publication association. Upon clicking the control, a user interface such as FIG. 16 may be displayed. Here a user may add a publication by filling in the input fields with the relevant information. Additionally, a user may upload an electronic copy of the publication which may be stored in one or more databases.

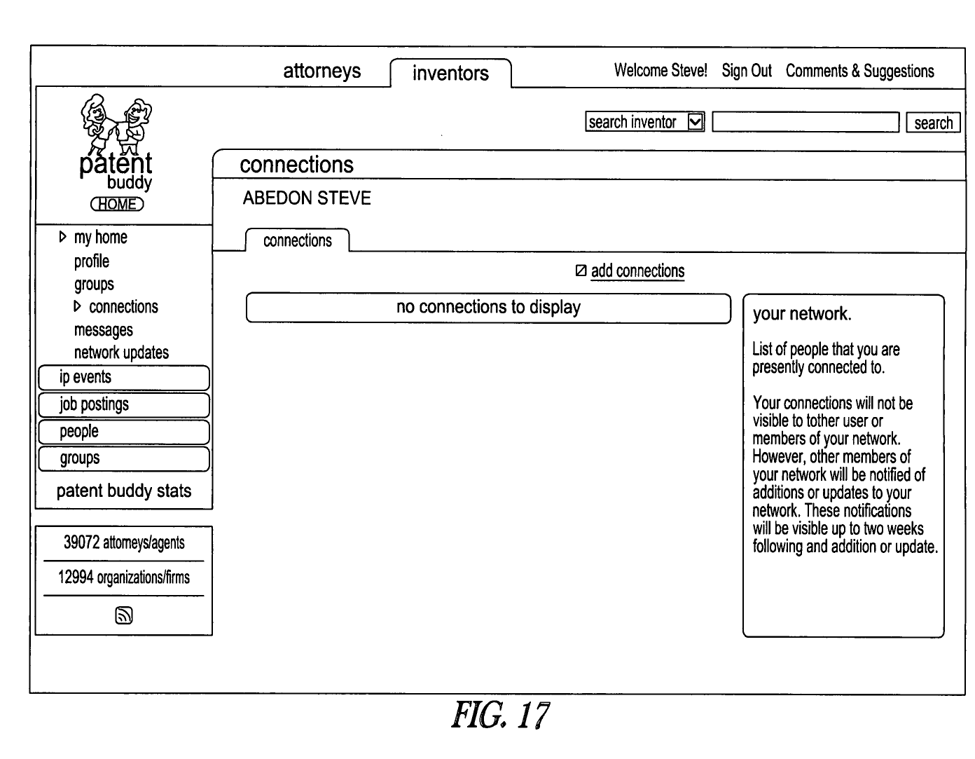

FIG. 17 illustrates an example user interface displaying connections. In an example embodiment, user profiles can designate other user profiles with which to be connected. As discussed above with reference to FIG. 3, connections may be reciprocal relationships such that if a first user profile designates a second user profile, the second user profile may designate the first user profile.

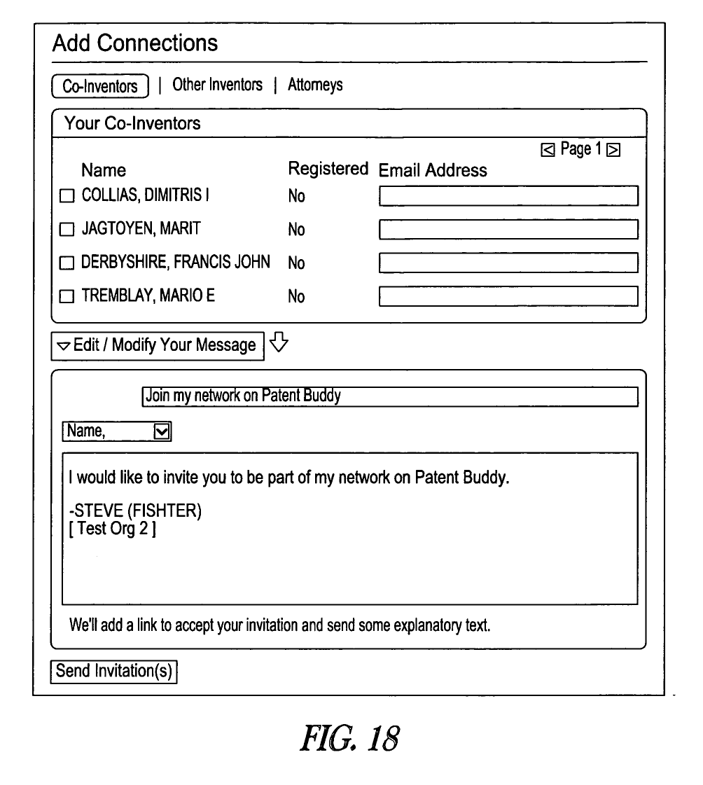

FIG. 18 illustrates an example user interface to add co-inventors as a connection. Shown are status indicators showing if the co-inventors have registered with the system and input fields for e-mail addresses and a message to be sent to the co-inventors selected using the check boxes provided on the interface.

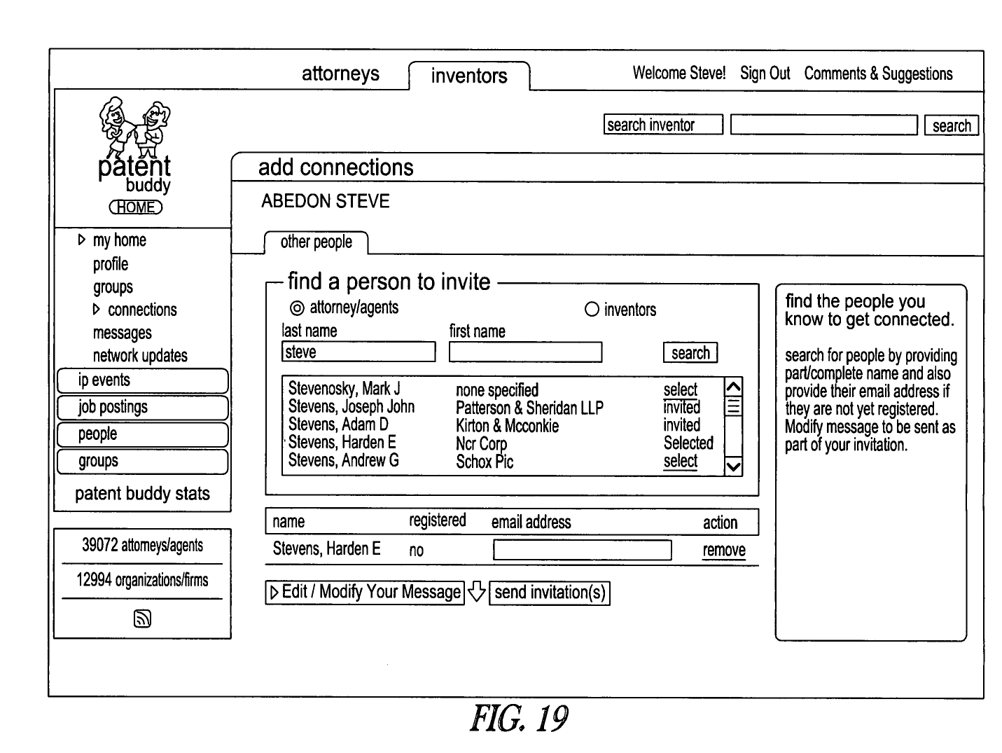

FIG. 19 illustrates an example user interface to add connections that are not co-inventors. Displayed is an example search interface with input fields for first and last names. As shown, connections may be made between attorneys/agents as well as inventors by using the displayed user selected indicia (e.g., the word select checkbox field, etc). In other example embodiments, any person affiliated with the patenting process may be made a connection (e.g., examiners). Further displayed is an example list of people that match the example search. Next to each displayed name may be a status indication. In this example, two of the people have already been invited and one person has been selected. The selected names may be shown below the search result list and invitations may be sent to establish a connection between the current user profile and the selected people. As shown, selected people may not be registered in the system but may still be sent invitations. The sent invitation may request the user register with the site and upon a successful registrations, the newly created user profile may automatically be connected with the requesting user profile.

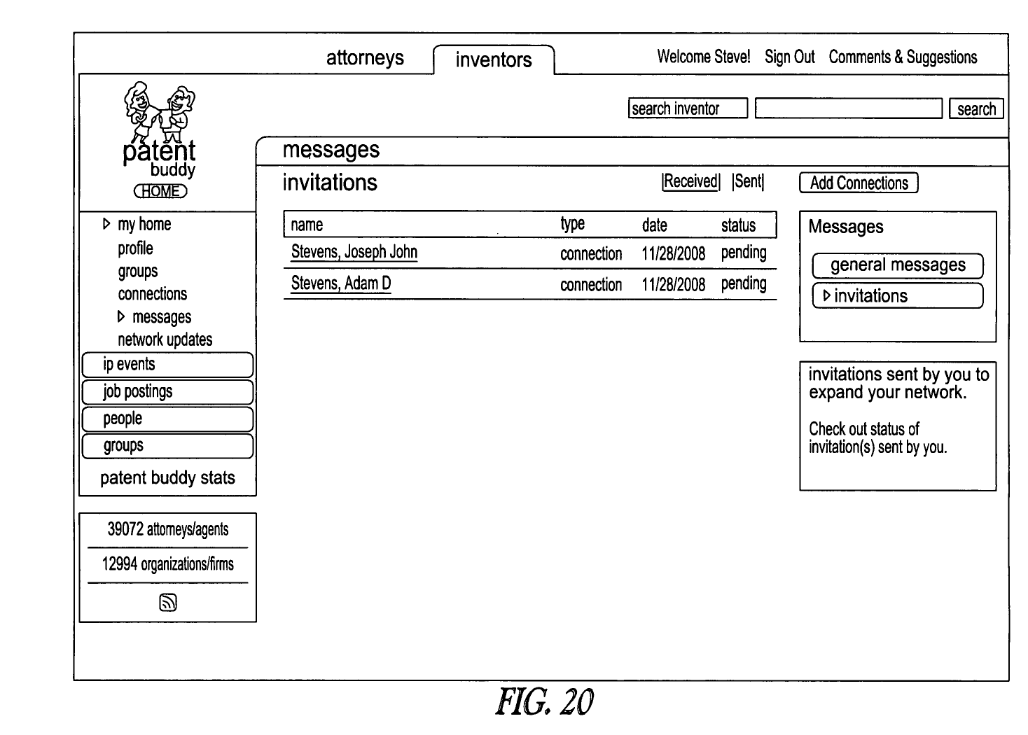

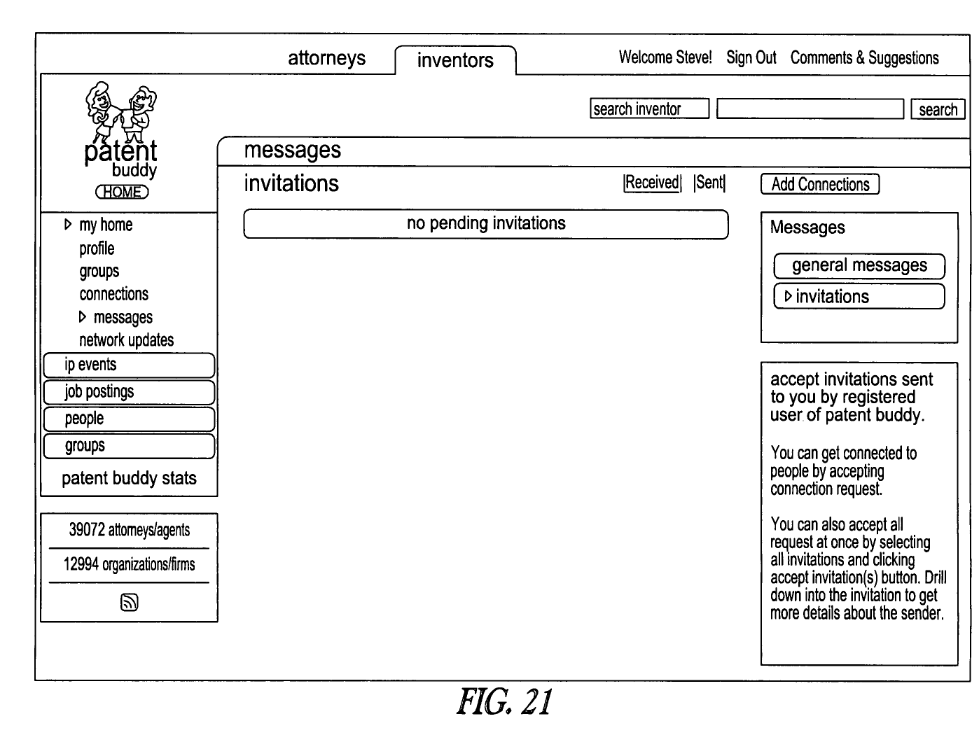

FIGS. 20-21 illustrate example user interfaces to facilitate messaging between user profiles. Messages may include connection requests. For example, FIG. 20 illustrates two outstanding example connection invitation requests along with a “pending” status. FIG. 21 illustrates an example user interface for received messages. As shown, there are no current pending invitation requests that have been sent to this example user profile.

In some example embodiments, the system presents suggested connections. The system may generate suggested connections by analyzing user profile data. For example, with reference to FIG. 3, example patent 316 lists two inventors, inventor 2 and inventor 4. In an embodiment, the system analyzes user profile 310 which corresponds to inventor 2 and suggest that a connection be established between user profile 310 and a user profile associated with inventor 4 (not shown). However, the connections are not limited to inventor relationships. The system might suggest that connections be made between an inventor user profile and an assignee user profile or an attorney user profile. In further example embodiments, connections are suggested based on already connected user profiles. For example, if user profile A is connected to profile B which is connected to profile C, the system might suggest a connection be made between profiles A and C.

Connection suggestions may also be based on relationships between patents, including but not limited to, citations of other patents, class/sub-class, geography, time, attorney, and examiner. The system may detect that a user profile designates a patent and that one or more additional patents have been cited within a patent. The system may identify inventors listed on the additional patents and suggest the inventors as connections. This information may be used in other components of the system as well. For example, a watch criteria may be set up to tell an inventor which other inventors are listed on patents being cited against him or her. Similarly, the system may suggest the examiner listed on the designated patents as a possible connection. Similarly, system may suggest connections between examiner and inventors listed on patents. The system may also suggest connections based on patents within the same class or sub/class. In further example embodiment, attorney suggestions may be presented to an inventor based on geographic location and art field.

A user may choose to view a sub-set of the suggested connections using filtering criteria. For example, the filtering criteria may include, but not limited to, geography, time in relationship to the present date, time in relationship to the identified patents, and number of connections shown.

FIG. 22A and FIG. 22B illustrate example user interfaces for adding and managing watches for people and international patent classes, respectively. In further embodiments, the watch lists includes updates on topics of interest. These topics may include other user profiles, patents, technology classes, or other information stored in system. Watches on user profiles may include similar information as that discussed above with connection updates. Watches on patents may include activity related to a patent. For example, if a user profile designates a patent as an associated patent, a message may be displayed in the watch list. Similarly, if a particular search class is being watched, when a patent issues within that search class a message may be displayed in the watch list.

In further example embodiments, search interfaces helps to facilitate users of the system to find other user profiles, patents, and other information stored in the one or more databases in the system. In an example embodiment, a search field is presented to the user and a category to search. The categories may include general fields of search such as user profiles, or more particular fields of search such as issued dates of patents. In some example embodiments, the search interface supports multiple search categories that may be disjunctively or conjunctively applied. The information entered into the search interface may be transmitted to the service device where a query may be formatted to find the requested data. In an example embodiment the query is formatted according to the Structured Query Language (SQL). The server device may process the query and display the search results on a display device.

In an example embodiment, one or more options may be presented next to the search results depending on the category of search. For example, if the search is for one or more patents, an option may be presented that allows the user to designate the patent as an associated patent. The system may then transform the user profile to include the designation and update the user profile database. Similarly, if the search is for other user profiles, an option may be presented to establish a connection to the user profiles returned in the search.

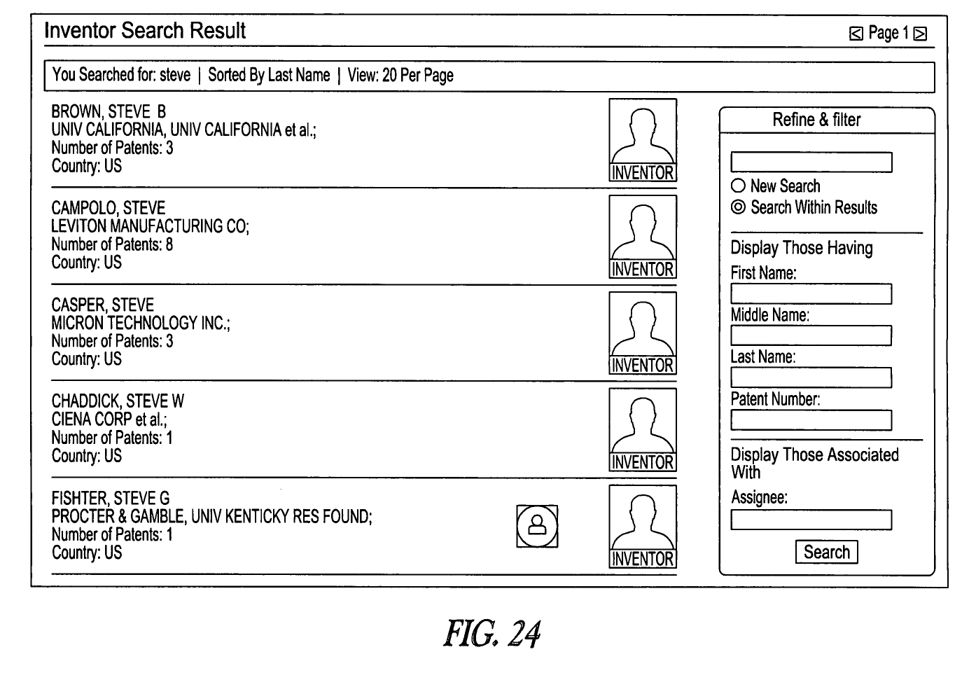

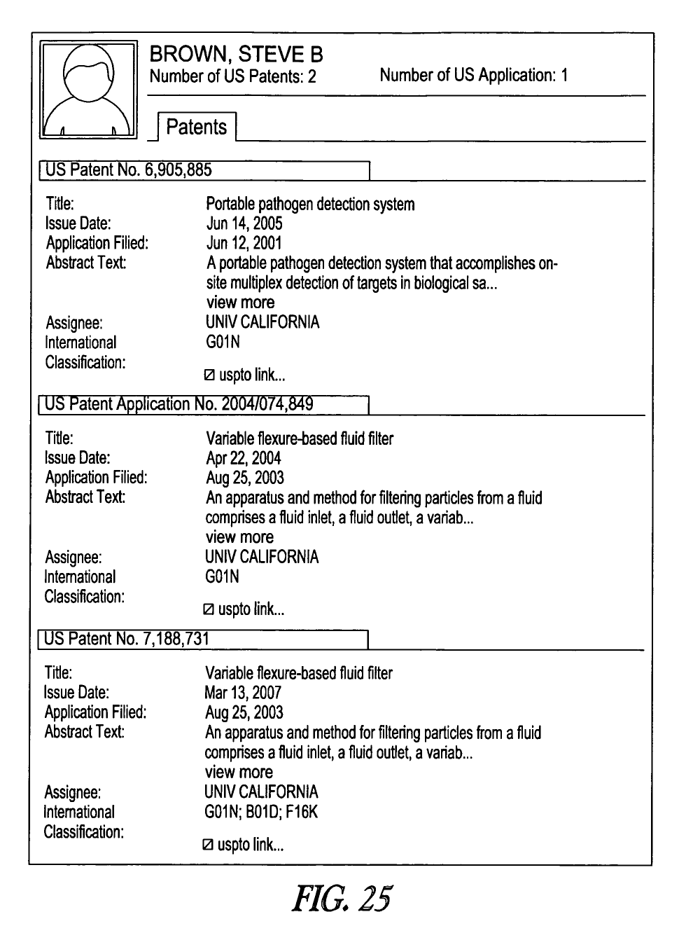

FIGS. 23-25 illustrate example search interfaces and search results. FIG. 23 illustrates an example search interface which includes options for searching for an inventor. Example input fields include inventor name, patent no., publication no., assignee, technical keywords, issues dates, and international patent classes. FIG. 24 illustrates example search results using the example search in FIG. 23. Displayed are badges next to one of the names signifying, in an example embodiment, that the inventor is a registered user. FIG. 25 illustrates example information which may be displayed for a person that is not registered in the system, but still has an association with a patent.

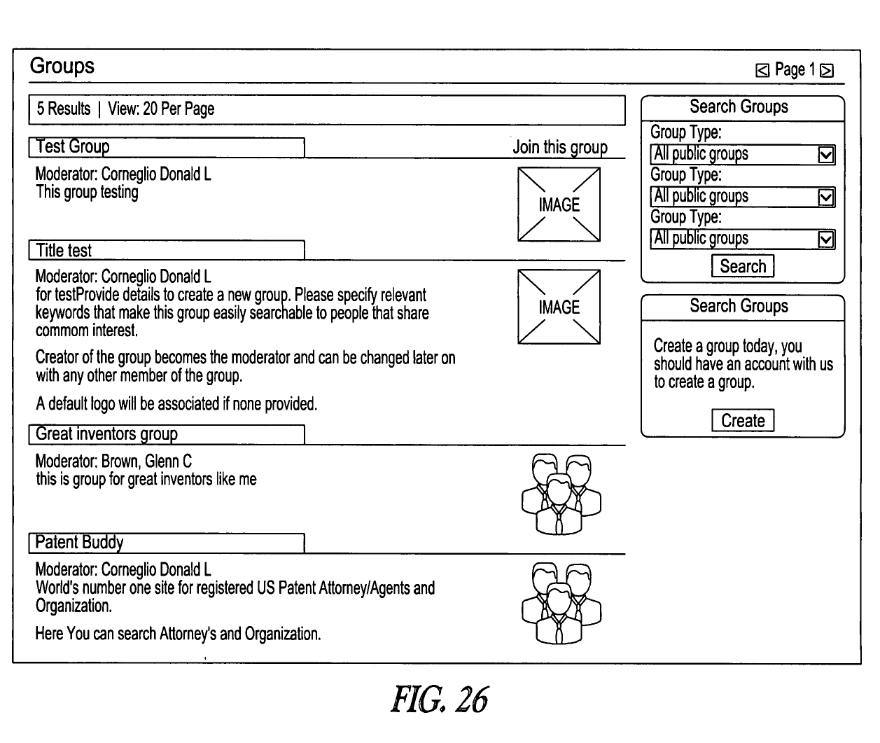

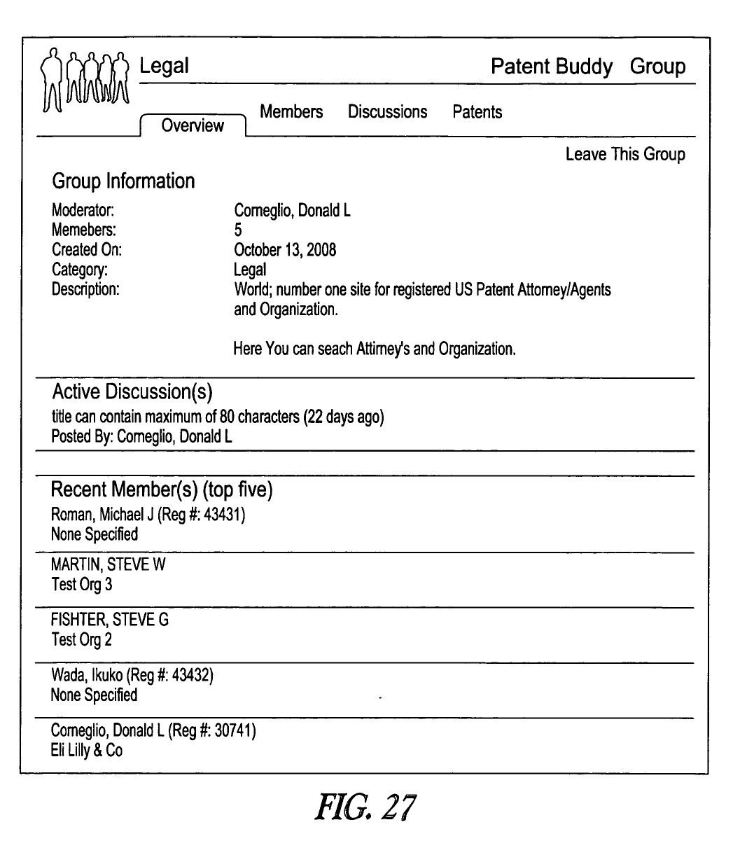

FIG. 26 illustrates an example group interface displaying one or more groups represented by one of more group records in the database. FIG. 26 displays a search interface to for searching created groups. Also displayed is an input button to create a new group. FIG. 27 illustrates an example group. In an embodiment, a group has a title, members, discussions, and patents. In an example embodiment, the overview tab includes the group information, discussions occurring within the group, and recent members.

### Distributed Computing Components

Some example embodiments may include the previously illustrated components (e.g., operations) being implements across a distributed programming environment. For example, operations providing logic functionality may reside on a first computer system that is remotely located from a second computer system containing an Interface or Storage functionality. These first and second computer systems can be configured in a server-client, peer-to-peer, or some other configuration. These various levels can be written using the above illustrated operation design principles and can be written in the same programming language, or a different programming language. Various protocols are implemented to enable these various levels, and operations contained therein, to communicate regardless of the programming language used to write these operations. For example, a module written in C++ using the Common Object Request Broker Architecture (CORBA) or Simple Object Access Protocol (SOAP) can communicate with another remote module written in Java. These protocols include SOAP, CORBA, or some other suitable protocol. These protocols are well-known in the art.

### A System of Transmission Between a Server and Client

In some embodiments, the above illustrated operations that make up the platform architecture communicate using the Open Systems Interconnection Basic Reference Model (OSI) or the Transmission Control Protocol/Internet Protocol (TCP/IP) protocol stack models for defining network protocols that facilitate the transmission of data. Applying these models, a system of data transmission between a server and client computer system can be illustrated as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications, whereas in other embodiments another protocol known in the art is used. Content from an application residing at the application layer is loaded into the data load field of a TCP segment residing at the transport layer. This TCP segment also contains port information for a recipient application or a module residing remotely. This TCP segment is loaded into the data field of an IP datagram residing at the network layer. Next, this IP datagram is loaded into a frame residing at the data link layer. This frame is then encoded at the physical layer and the content transmitted over a network such as the Internet, Local Area Network (LAN) or Wide Area Network (WAN). The term Internet refers to a network of networks. Such networks may use a variety of protocols for exchange of information, such as TCP/IP etc., and may be used within a variety of topologies or structures. This network may include a Carrier Sensing Multiple Access Network (CSMA) such as an Ethernet-based network. This network may include a Code Division Multiple Access (CDMA) network or some other suitable network.

### A Computer System (Switch to FIG. 26)

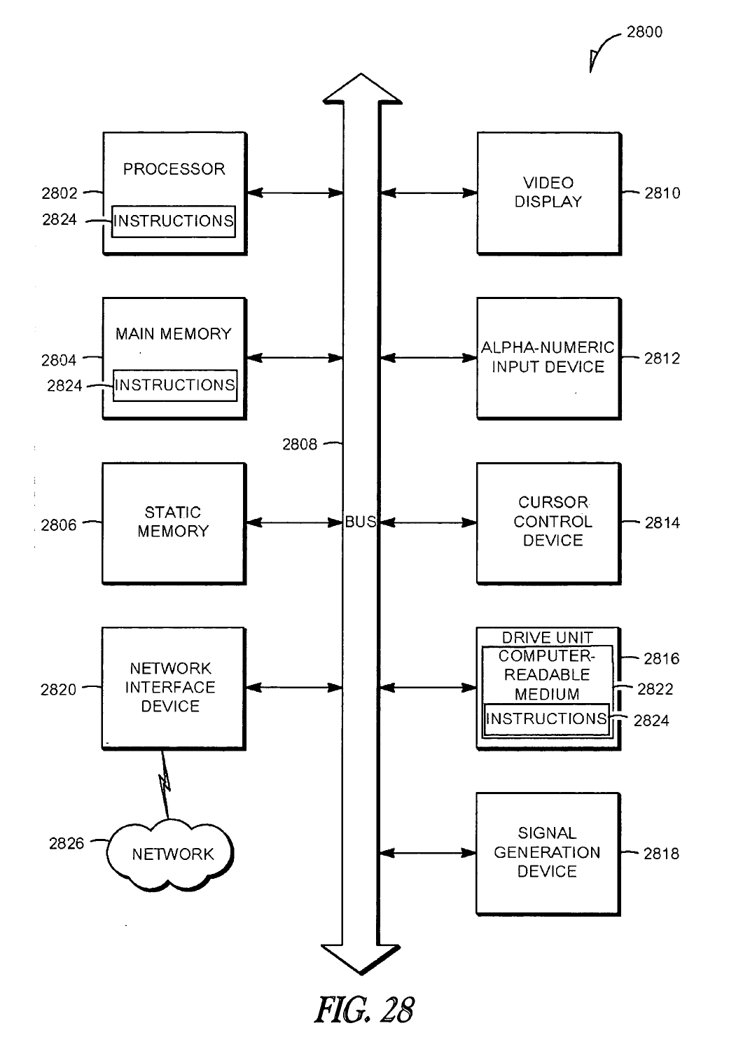

FIG. 28 shows a diagrammatic representation of a machine in the example form of a computer system 2800 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The exemplary computer system 2800 includes a processor 2802 (e.g., a central processing unit (CPU) a graphics processing unit (GPU) or both), a main memory 2804 and a static memory 2806, which communicate with each other via a bus 2808. The computer system 2800 may further include a video display unit 2810 (e.g., a liquid crystal display (LCD) or a cathode ray tube (CRT)). The computer system 2800 also includes an alphanumeric input device 2812 (e.g., a keyboard), a cursor control device 2814 (e.g., a mouse), a disk drive unit 2816, a signal generation device 2818 (e.g., a speaker) and a network interface device 2820.

The disk drive unit 2816 includes a machine-readable medium 2822 on which is stored one or more sets of instructions (e.g., software 2824) embodying any one or more of the methodologies or functions described herein. The software 2824 may also reside, completely or at least partially, within the main memory 2804 and/or within the processor 2802 during execution thereof by the computer system 2800, the main memory 2804 and the processor 2802 also constituting machine-readable media.

The software 2824 may further be transmitted or received over a network 2826 via the network interface device 2820.

While the machine-readable medium 422 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

It is to be understood that the above description is intended to be illustrative, and not restrictive. For example, the above-illustrated embodiments (and/or aspects thereof) may be used in combination with each other. Many other embodiments may be apparent to those of skill in the art upon reviewing the above description.

What is claimed is:

1. A computer system comprising:
one or more processors;
one or more storage devices in communication with the one or more processors;
a plurality of inventor profile records stored on the one or more storage devices, the plurality of inventor profile records each recording a name of a living person in a name field;
a plurality of patents represented by a plurality of patent records stored on the one or more storage devices, wherein each patent record records at least an inventor name and a patent number, in respectively, at least one inventor name field and a patent number field;
a computer program operable on the one or more processors, a first portion of the computer program adapted to:
display a patent search interface on a display device, the patent search interface including at least one field or selection tool to receive patent search criteria input from at least one user input device to match to one or more fields in a patent record;
search the plurality of patent records using the patent search criteria to match at least one patent record that includes at least one field that matches a portion of the patent search criteria;
display information on the display device obtained from the at least one patent record, where in the information identifies at least one patent and display user selectable indicia to allow a user to select one or more patent records from the at least one patent record;
add or modify an inventor profile record to include data that identifies the one or more patent records selected by the user;
a second portion of the computer program adapted to:
display a profile search interface on the display device, the profile search interface including at least one field or selection tool to receive profile search criteria including an inventor name from the at least one user input device to match to one or more fields in an inventor profile record;
search the plurality of inventor profile records using the profile search criteria to match at least one inventor profile record that includes at least one field that matches the inventor name;
display profile information on the display device including an inventor obtained from the at least one profile record and display further user selectable indicia to allow a user to select one or more inventor profile records with which to create a connection; and
add or modify the inventor profile record to include data that identifies the one or more inventor profile records selected as being a connection between two people and having a relationship in the database
wherein each inventor profile record includes patents that have been selected and connections that have been created.

2. The computer system of claim 1, further including a plurality of attorney profile records stored on the one or more storage devices, the plurality of attorney profile records each recording a name of a living person in a name field.

3. The computer system of claim 1, wherein a patent record includes geographic information obtained from the patent.

4. The computer system of claim 1, wherein a first patent record includes other patents listed in a patent associated with the first patent record.

5. The system of claim 1, wherein suggested connections are displayed for a first inventor profile record on the display device according to data identifying one or more patents stored in the first inventor profile record.

6. The system of claim 5, wherein a patent record includes priority data information obtained from the patent and wherein the suggested connections are sorted according to the priority data information.

7. The computer system of claim 1, further including
a monitoring module to monitor at least one attribute selected from the group consisting of keyword, geography, technology, and co-inventor stored in one or more fields of a first inventor profile record.

8. The computer system of claim 7, wherein the monitoring module monitors the at least one attribute every hour.

9. The computer system of claim 7, wherein information associated with the at least one attribute includes issued patents.
